(19) United States
(12) Patent Application Publication
(10) Pub. No.: US 2024/0174125 A1
(43) Pub. Date: May 30, 2024

(54) System for Controlling a Mining Truck and Method for Controlling a Mining Truck

(71) Applicant: ABB Schweiz AG, Baden (CH)

(72) Inventor: Gunnar Hammarström, Västerås (SE)

(21) Appl. No.: 18/552,260

(22) PCT Filed: Mar. 25, 2021
(86) PCT No.: PCT/EP2021/057768

§ 371 Date: Sep. 25, 2023

(51) Int. Cl. B60L 58/12; B60L 5/00

(52) U.S. Cl. CPC B60L 58/12; B60L 5/00; B60L 2200/30; B60L 2200/36; B60L 2200/40

(57) ABSTRACT

A system and method for controlling the state of battery of a trolley assisted mining truck connectable to one or more trolley line(s), the trolley assisted mining truck carrying out an operation schedule including transport cycles. The system includes a battery charge status unit for determining battery charge status data indicative of the present charge status of the battery of the mining truck; a transport status unit for determining progress data of the progress of the mining truck in a present transport cycle; and a control unit for determining a schedule condition indicative of whether the operation schedule can be met and maintained. The control unit is configured to adapt, in case of the schedule condition being determined to be not satisfactory, at least one operational parameter and/or the operation schedule of the mining truck for obtaining a sustainable state of battery charge.

### TECHNICAL FIELD

The current invention relates in general to a system for controlling a mining truck, and in particular a trolley assisted mining truck. The current invention further refers to a method for controlling a mining truck and especially a trolley assisted mining truck. In particular, the system and the method relate to a system and a method for controlling the electrical charging and the state of battery of a mining truck.

### BACKGROUND

Mining trucks are often used for transporting material hauled inside or out of a mine. For instance, trucks may be used for transporting hauled material inside or out of an open pit mine. When transporting the material out of the mine, several parameters have to be considered, which may hamper the transport of material. The material is often heavy and the mining trucks are adapted to high loads. Some mining trucks transport up to 350 tons (inclusive payload) or even more. Additionally, for driving out of the mine, steep inclines may have to be overcome. In some mines, the mining trucks have to overcome a vertical gain of about 500 meter or more. For such transports, the energy consumption is high.

Additionally, the mining trucks may be planned to run for 22 h or even more per day. For these kinds of applications, a combined trolley and onboard battery solution is already today feasible for the mining trucks. The mining trucks have a battery onboard for delivering the power to an electrical drive of the mining truck. The connection to a trolley line, being e.g. provided at a place of high energy consumption, allows direct supply of electricity to the truck, e.g. in the steep inclines. This may mean that the battery only needs to cover the relatively flat travel passages at the top and bottom of an open pit mine. Some kinds of mining trucks have an additional diesel engine for avoiding a sudden stop of the electric drive and for delivering current to the electric drive of the mining truck.

Further topping up the battery of the mining truck with stationary charging is often not a viable solution given the (almost) around-the-clock operation of the truck, and, at the same time, substantial charging of the battery is required, in particular in view of the heavy load and the transport conditions. However, there are also external factors that can vary with major impact on the energy consumption per km, such as running resistance, additional load and weather conditions, which can consequently lead to a situation, where the normal transport cycle of the mining truck via trolley is no longer self-sustainable in terms of battery charging. The truck would become standing with a flat battery, possibly after several transport cycles. A standing mining truck, especially with an empty battery in the middle of the transport path, may seriously impede the production and generates high costs. Should the factor affect all trucks in the mine, weather conditions a possible example, the whole production could stop.

In view of the above, there is a need to address at least one of the abovementioned limitations and propose a method and system to overcome the abovementioned problems.

### Summary

In an embodiment, the present invention relates a system for controlling the electrical charging and/or state of battery of a trolley assisted mining truck connectable to one or more trolley lines, the trolley assisted mining truck having an electric drive and a battery for delivering energy to the electric drive. The trolley assisted mining truck carries out an operation schedule including predefined transport cycles. The system includes, a detection unit including a battery charge status unit for determining battery charge status data indicative of the present charge status of the battery of the trolley assisted mining truck, and a transport status unit for determining progress data of the progress of the trolley assisted mining truck in a present transport cycle of the operation schedule. The system further includes a control unit for determining a schedule condition indicative of whether the operation schedule can be met and maintained based on the battery charge status data determined by the battery charge status unit and the progress data determined by the transport status unit. The control unit is further configured to adapt, in case of the schedule condition being determined to be not satisfactory, at least one operational parameter and/or the operation schedule of the trolley assisted mining truck for obtaining a sustainable state of battery charge.

In an embodiment, the present invention discloses a method for controlling the electrical charging and/or the state of a battery of a trolley assisted mining truck connectable to one or more trolley line(s), the trolley assisted mining truck having an electric drive and a battery for delivering energy to the electric drive. The trolley assisted mining truck carries out an operation schedule including predefined transport cycles. The method includes determining by a battery charge status unit battery charge status data indicative of the present charge status of the battery of the trolley assisted mining truck; and determining by a transport status unit progress data of the progress of the trolley assisted mining truck in a present transport cycle of the operation schedule. The method further includes determining by a control unit a schedule condition indicative of whether the operation schedule can be met based on the charge status determined by the battery charge status unit and the progress data determined by the transport status unit, and, in case of the schedule condition being determined to be not satisfactory, adapting at least one operational parameter and/or the operation schedule of the trolley assisted mining truck for obtaining a sustainable state of battery charge.

Systems of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

The subject matter of the invention will be explained in more detail in the following text with reference to preferred exemplary embodiments which are illustrated in the drawings, in which:

FIG. 1 shows a schematic drawing of a system for controlling the electrical charging of a trolley assisted mining truck according to some embodiments described herein;

FIG. 2 shows a schematic drawing of at least parts of a system for controlling the electrical charging of a trolley assisted mining truck according to some embodiments described herein;

FIG. 3 shows a schematic drawing of at least parts of a system for controlling the electrical charging of a mining truck according to some embodiments described herein;

FIG. 4 shows a schematic drawing of at least parts of a system for controlling the electrical charging of a trolley assisted mining truck according to some embodiments described herein;

FIG. 5 shows a schematic flow chart of a method for controlling the electrical charging of a mining truck according to some embodiments described herein; and

FIG. 6 shows a schematic flow chart of a method for controlling the electrical charging of a mining truck according to some embodiments described herein.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can be applied to a corresponding part or aspect in another embodiment as well.

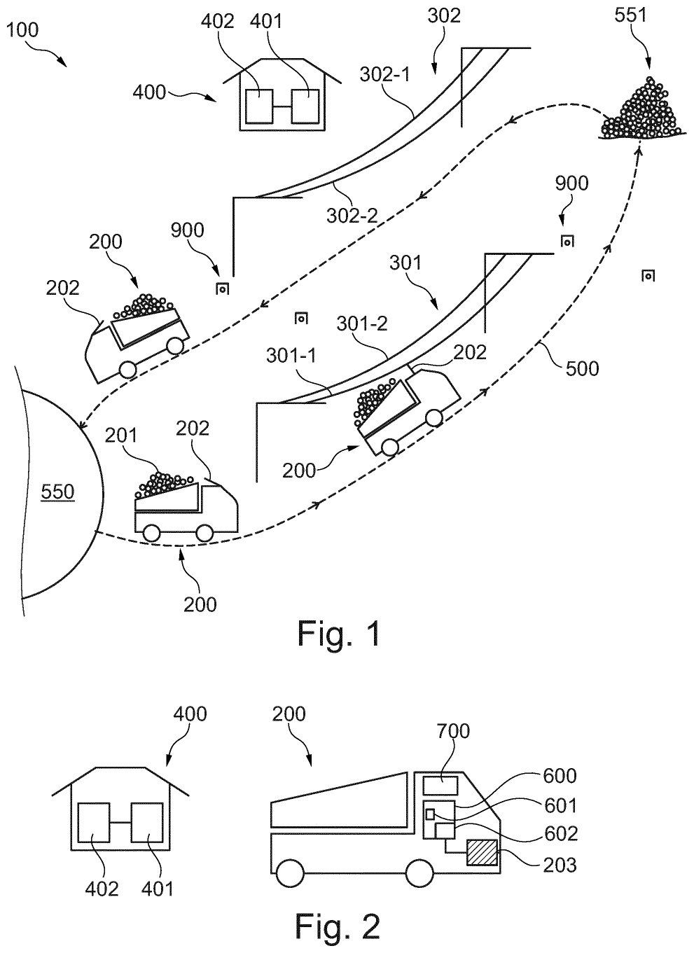

FIG. 1 shows a system 100 for controlling the electrical charging and/or state of battery of a trolley assisted mining truck 200 according to some embodiments described herein.

Typically, a system as referred to herein may be a multi-part device having one or more units. According to some embodiments, the one or more units of the system described herein may be capable of performing different functions. Typically, the one or more units of the system may be distributed at different locations, or may be located at one location only. According to some embodiments described herein, the one or more units of a system as described herein may act together, perform together, compute together, communicate with each other, exchange information with each other, control each other, and/or perform single parts of an overall task of the system.

Typically, FIG. 1 shows a mine 550, which may in particular be an open pit mine. One or more trolley assisted mining trucks 200 (in the following often just described as mining trucks 200) transport material 201 hauled from the loading location in the mine 550 along a transport cycle 500 (shown as dashed line in FIG. 1). According to some embodiments described herein, the mining trucks 200 upload a material load 201 at the loading location in the mine, e.g. at the ground of an open pit mine. The mining truck 200 transports the load 201 along the transport cycle 500 to an unloading place 551, where the material load 201 of the mining truck 200 is unloaded from the mining truck. The empty mining truck 200 goes from the unloading place 551 to the mine 550, again along the transport cycle 500. At the mine 550, the transport cycle 500 absolved by the mining truck 200 begins again with uploading a material load 201 on the mining truck 200.

Generally, a transport cycle as used may be understood as a cycle ranging from an upload location (where the material load is uploaded to the mining truck, such as in the mine 550) to an unload location (where the material is unloaded from the truck, such as unloading place 551) and back to the upload location. In particular, parts of the transport cycle may be provided with a trolley line, e.g. one or more sections of the transport cycle may be provided with a trolley line. Typically, the transport cycle may include a path along which the mining truck travels.

As can be seen in the embodiment of FIG. 1, parts of the transport cycle 500 according to embodiments described herein may be equipped with a trolley line 301, 302. In particular, a part of the transport cycle 500 being equipped with trolley lines may be a part of the transport cycle having a steep incline (such as a part of the transport cycle leading out of the pit, or into the pit), or other power consuming conditions (like for instance environmental conditions, such as ground conditions or the like). Typically, each of the trolley lines 301, 302 has two contact wires 301-1, 301-2 and 302-1, 302-2, respectively, which indicate one contact wire for a positive pole and one contact wire for a negative pole for each trolley line.

According to embodiments described herein, a trolley line may be understood as including current conducting wires, such as contact wires. Typically, a trolley or the mining truck can be fed by DC current. As shortly mentioned above, the truck may be connected to at least two contact wires, one at positive voltage in relation to the second contact wire and one other conductor (consequently) at negative voltage in relation to the first conductor. Typically, the contact wires of a trolley line according to embodiments described herein may be placed in a height and at a location, where the mining truck is able to contact the trolley line, in particular via the pantograph of the mining truck. Typically, the trolley line may be held by holding device(s), such as an electrical tower. In some embodiments, the trolley line may be controlled by a control unit and/or a traffic management tool, as described herein and explained in detail below. Typically, the trolley line wires may be connected to a substation that provides electrical power.

According to embodiments described herein, the mining truck is connectable to one or more trolley line(s), especially electrically connectable to one or more trolley line(s). According to some embodiments described herein, the mining truck includes a pantograph 202 (especially a trolley pantograph), especially for being connectable to the trolley lines. Typically, the pantograph 202 may be placed to be in contact with the trolley line 301, 302, when the mining truck 200 drives under the trolley line 301, 302. For instance, the pantograph 202 of the mining truck 200 may be in an idle position, when the mining truck does not travel under a trolley line (as for instance shown in FIG. 1 by the mining truck 200 being near to the mine 550). When the mining truck 200 is under a trolley line, or approaches a trolley line, the pantograph 202 of the mining truck may be put in a power transferring position (as for instance shown by the mining truck 200 under the trolley line 301 in FIG. 1). Typically, when the mining truck 200 is under a trolley line, the battery of the mining truck 200 may be charged with electrical power via the trolley 202 being in contact with the trolley line 301, 302.

According to embodiments described herein, a trolley assisted mining truck (or mining truck as used herein) may be understood as a truck being adapted for transporting (heavy) loads out of a loading area of a mine, such as an open pit. The trolley assisted mining truck may have an electric drive and a battery for providing power to the electric drive. In particular, the trolley assisted mining truck may include a pantograph for propelling the truck without use of power from the battery, or for charging the battery of the mining truck, or for a combination thereof, especially via the contact of the pantograph with a trolley line. Typically, the trolley assisted mining truck may be adapted for a weight of up to 600 tons, or more. Typically, the mining truck as described herein may have a power of typically between about 150 kW and about 7 MW, more typically between about 400 kW and about 6 MW, and even more typically between about 2 MW and about 5 MW. In some embodiments, the mining truck as described herein may have a power of about 5 MW. In particular, the mining truck as described herein, and especially the electric drive and the battery of the mining truck, may be adapted to an operation time of 22h or more per day, especially without a stationary charging break (i.e. a break where the mining truck has to stop for charging). Especially, the electric drive and the battery of the mining truck may be adapted for such an operation by adapting the size, the power, the used materials, the isolation, the location, and the like of the battery and the electric drive. Normally (e.g. under nearly ideal conditions), the system 100, including trolley lines and mining trucks, is designed so that the charging via trolley is self-sustainable during each transport cycle and the trucks are used (almost) around the clock.

According to embodiments described herein, it is sometimes not possible to charge the battery of a trolley assisted mining truck with at least the same energy via the trolley lines as the mining truck consumes during a transport cycle. For instance, several things can happen during operation so that the charging is not self-sustainable in the way it is designed to be in the normal (e.g. nearly ideal) conditions. As an example, the insufficient charging can be a result of a running resistance of the roads being higher than normal increasing the energy consumption per cycle, or a result of a part of the trolley line being out of operation (such as equipment for supplying electrical energy, loss of some electronic support systems or the like). If no special action is taken this will—over time—lead to an empty battery for one or several or all trucks. If that is the case, the trolley will stop sooner or later and will not contribute to the production anymore. The mining truck with the empty battery may even hamper the production of other trucks if it halts in the wrong place. Due to the operation hours (almost around the clock) stationary charging is not a feasible alternative. The system according to embodiments described herein is concerned about mitigation strategies and measures to avoid a stop of one or more mining trucks to happen during production. In particular, the system and method according to embodiments described herein offer a self-sustainable charge cycle, even if the conditions call for a higher energy consumption of the mining truck during a transport cycle.

According to embodiments described herein, a system is provided receiving information of the actual status of the battery charge as well as the actual status of the transport cycle and, especially, about what parts in the cycle can be charged via trolley. The system according to embodiments described herein will detect (based on the data of the battery and the transport cycle, and possibly additional data) whether the transport cycle is able to sustain a defined charging level. If not, the system may calculate measures for avoiding a stop of the mining truck. Typically, the system may calculate measures for obtaining (or calculating) a sustainable state of battery charge. In some embodiments, which may be combined with other embodiments described herein, the system may calculate measures for changing, especially increasing, the electrical charging of the battery of the mining truck via trolley.

The calculated measures may for instance include information abut how much slower the mining truck can go under the trolley to get enough charging to achieve a sustainable charge cycle. An alternative strategy to achieve a sustainable cycle may be to increase the charging power, or a combination of both (the reduced velocity of the mining truck and the increased charging power). In some embodiments, the transport cycle or the operation schedule may be changed for one or more mining truck (s) for obtaining a sustainable state of battery charge. For instance, the route of the one or more mining truck(s), which show a charging too low for the planned operation, may be changed, e.g. by changing the path of the transport cycle, by instructing the mining truck to go to a nearer location for unloading its payload, by uploading the payload at a location not as far away, or by loading less payload on the mining truck. The calculated information or strategy is used to change the operation of the mining trucks accordingly, via a control system, via information/instruction to operator or in other way.

Typically, there is a tradeoff between velocity of charging and battery lifetime. According to embodiments described herein, the calculated strategy for the one or more mining truck(s) may lead to a lower production or decreased battery lifetime (especially if only the higher charging power is used for ensuring a sustainable operation of the mining truck), but this may be minor drawbacks compared to halted production. In some embodiments, the battery life span may be considered and factored, when calculating a strategy for obtaining a sustainable operation of the mining truck, as explained in detail below.

Going back to FIG. 1, the system 100 according to embodiments described herein further includes a control unit 401, typically for determining the need of measures and calculating suitable measures to take. As shown in the embodiment of FIG. 1, the control unit 401 may be part of or located in a traffic management tool 400. However, the control unit 401 may also be placed elsewhere.

According to embodiments described herein, the system 100 further includes a detection unit. The detection unit 600 (as exemplarily shown in FIG. 2) includes a battery charge status unit 602. The battery charge status unit 602 is adapted for determining battery charge status data of the actual or present charge status of the battery 203 of the mining truck 200, especially the current state of the battery of the mining truck.

FIG. 2 shows a part of the system 100 according to embodiments described herein. FIG. 2 shows a mining truck 200 including a battery 203, a detection unit 600 and a battery charge status unit 602 being especially connected to the battery 203 of the mining truck 200. The battery charge status unit 602 may include sensors or current sensing or measuring devices for determining the charge status of the battery.

According to embodiments described herein, the system 100 further includes a transport status unit 601 for determining progress data of the progress of the trolley assisted mining truck 200 in a present transport cycle 500 of an operation schedule.

According to some embodiments described herein, an operation schedule as described herein may be understood as a schedule for the operation of a mining truck. In particular, an operation schedule may include information for the mining truck about the work to do. For instance, the operation schedule may include information for the truck about the transport cycles to do. According to some embodiments, an operation schedule may include a plan for an infinite number of transport cycles. For instance, the infinite number of cycles may be expressed in that the battery shall after a transport cycle be in state so that the number of transport cycles can be extended arbitrary. Generally, the operation schedule may include information like parameters of the transport cycle, the kind of transport cycle, the path of the transport cycle, the length of a transport cycle, the duration of a transport cycle, a number of transport cycles, the position of the trolley line, the length of a trolley line, target operational parameter of the mining truck (such as the velocity of the mining truck, the payload of the mining truck and the like), and target charging parameters for the electrical charging of the mining truck (such as charging energy, charging time and the like). In some embodiments, the operation schedule may include a predefined number of transport cycles to go for one mining truck. In some embodiments, the operation schedule may include information or data about a number of transport cycles to do within a defined time slot or time frame, e.g. within a time frame until the next break for the mining truck, such as a charging break, a maintenance break, a control break or the like. The time frame of an operation schedule may for instance include the work to do within a time frame of the next 22 hours or more.

It may be understood that the operation schedule is a plan for the operation of a mining truck under defined, especially optimal, circumstances and defined, especially optimal, conditions. Nevertheless, the operation schedule may be calculated with some deviations from optimal circumstances and conditions. Typically, an operation schedule may be set by a traffic management tool, or an operator, especially an operator using the traffic management tool.

The transport status unit 601 may gather or determine progress data of the progress of the mining truck 200 according to the operation schedule and, typically, the transport cycle, and more typically the present transport cycle. The transport status unit 601 can for instance determine, at which location the mining truck is located, how many transport cycles the mining truck has already absolved, how many transport cycles the mining truck still has to go, how far the mining truck is from the next trolley line, and the like. In particular, the transport status unit 601 may determine or gather progress data including the position of the mining truck 200, the distance of the mining truck 200 to the trolley line 301, 302, the overall length of the transport cycle 500, the remaining length of the transport cycle 500 in the actual transport cycle, the duration of one transport cycle 500, the number of transport cycles already gone by the trolley assisted mining truck 200, the number of transport cycles still planned to go by the trolley assisted mining truck 200 in the operation schedule, the time of operation of the trolley assisted mining truck 200, the remaining time of operation planned for the trolley assisted mining truck 200 in the operation schedule, and/or the payload 201 on the mining truck 200 in the actual and/or previous transport cycle(s).

According to some embodiments described herein, the data determined or gathered by the battery charge status unit 602 and the transport status unit 601 may be used to change the operation of the mining truck(s) accordingly, via a control system, via information/instruction to an operator or in another way, as will be explained in detail below.

According to embodiments described herein, the control unit may be adapted for determining a schedule condition. A schedule condition according to some embodiments described herein may be understood as a kind of test or check whether the operation schedule can be met or maintained by the mining truck. In particular, the control unit may be adapted for performing a comparison between the operation schedule and the determined data of the battery charge status unit and the transport status unit. Typically, the control unit may calculate, based on the determined data of the battery charge status unit and the transport status unit, what kind of operation of the mining truck is possible, e.g. how many transport cycles are still possible with the actual battery charge status. According to some embodiments, the control unit may compare the determined kind of operation with the predetermined operation schedule. For instance, the operation schedule may be checked on feasibility by the control unit.

Typically, the schedule condition may be indicative of whether the operation schedule can be met or maintained based on the battery charge status data determined by the battery charge status unit 602 and, especially, the progress data determined by the transport status unit 601. In case of the schedule condition being determined to be not satisfactory by the control unit (i.e. the operation schedule can not be met with the actual status data), the control unit 401 is further configured to adapt at least one operational parameter of the trolley assisted mining truck 200. The operational parameter may for instance be a velocity of the mining truck (especially in contact with the trolley line), a charging power for the mining truck, a payload to be loaded on the mining truck (e.g. a limit for the payload loaded on the mining truck in the next transport cycle), turning on or off defined (optional) functions of the mining truck, reducing the energy consumption of the battery, changing the transport cycle of the mining truck (e.g. length, route, unload and upload locations, changing the payload loaded on the mining truck in the next transport cycles etc.) and the like.

According to embodiments described herein, the control unit may be configured to adapt an operational parameter and/or the operation schedule for obtaining a sustainable state of battery charge. In this way, a sustainable state of charge for the planned transport cycles may be achieved. One possible measure of adapting the operation schedule may for instance be to change the transport cycles for the one or more mining truck with insufficient battery charging to something slightly less demanding. Changing the transport cycle of one mining truck (or of the mining trucks having an insufficient battery charge for the planned operation) would not affect the production so it may be an attractive solution.

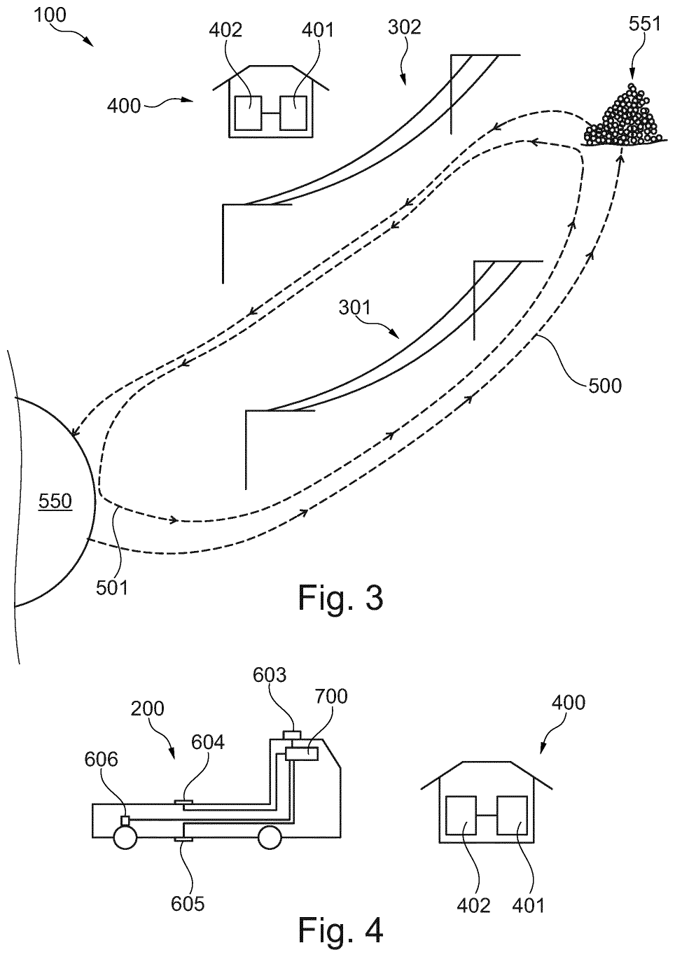

FIG. 3 shows an example of an adapted transport cycle 501 being shown in a dotted line. The control unit may for instance adapt the transport cycle in case the mining truck has an insufficient battery charge for the operation schedule. According to some embodiments, the transport cycle may be adapted alternatively or additionally to increasing the electrical charging of the mining truck via the trolley lines 301, 302. The adapted transport cycle 501 may be an alternative path 501 for the mining truck. For instance, the adapted transport cycle 501 may include abbreviations (such as shorter paths to the upload location of the mine 550 and the unloading place 551), alternative paths including different ground conditions (such as paths causing less wheel suspension movement, or having a lower running resistance), alternative paths having a steeper incline in the way down into the mine 550, alternative paths having a less steep incline in the way out of the mine, and/or defining less payload in the transport cycle. According to some embodiments, the alternative paths of the adapted transport cycle may not be suitable for all of the mining trucks, e.g. due to lacking stability for several heavy mining trucks, but may be used in exceptional cases for mining trucks with a low battery charge level. Typically, the information and data about the adapted transport cycle may be communicated to an operator, to the traffic management tool, to an operator using the traffic management tool, via a communication unit, and the like.

According to some embodiments, which may be combined with other embodiments described herein, the control unit may be configured to adapt an operational parameter for changing, especially increasing, the electrical charging of the trolley assisted mining truck via the trolley line 301, 302. According to some embodiments, the control unit may be configured to reduce (or to instruct to reduce) the energy consumption of the battery of the mining truck. In some embodiments, the electrical charging may be adapted additionally or alternatively to the adaption of the transport cycle as exemplarily described above. For instance, the control unit may be provided with control devices for performing the above described function, e.g. processing power, storage devices for storing (at least temporarily) the data received from other units in the system, and communication devices for communicating with other units in the system.

According to some embodiments, the control unit may be configured to factor the life span of the battery when calculating the battery charging power, if the control unit adapts the at least one operational parameter and/or the operation schedule of the trolley assisted mining truck for obtaining a sustainable state of battery charge. For instance, a high-power charging of the battery may influence the life span of the battery, e.g. by decreasing the estimated life span of the battery. As a primary objective, the control unit may instruct to charge the battery as needed for sustainable transport cycles. But, achieving sustainable transport cycles, the battery charging power may be kept as low as possible to increase battery life span. In some embodiments, which may be combined with other embodiments described herein, the control unit may be adapted to calculate an optimum of battery charging of the mining truck and life span of the battery. In this way, a compromise may be made between best charging and longest possible life span of the battery. In some embodiments, the control unit may use further information and/or data for calculating the best compromise or the optimum of charging and life span of the battery, such as age of the battery, age of the mining truck, equipment of the mining truck, actual season of the year, outside temperature and the like.

According to some embodiments, which may be combined with other embodiments described herein, the system may include an operational scenario tool. In some embodiments, the operational scenario tool may for instance be part of the control unit. Typically, the operational scenario tool may be configured to create different operational scenarios of the mining truck 200 based on the data gathered by the detection unit 600 and the transport status unit 601. For instance, the operational scenario tool may create scenarios of different charging strategies, different strategies regarding the transport path, the production, and the like. The operational scenario tool may for instance set up the following scenarios, when the schedule condition of a mining truck is not satisfactory: a scenario with not increasing the charging power, but increasing the life span of the battery (including the time or the number of transport cycles until the mining truck will stop due to empty battery); a scenario with charging the mining truck with a maximum of power, but decreased life span of the battery (including the impact on production and cost of a battery change of the mining truck); a scenario, where the charging power is as low as possible for preserving the battery (including a remaining risk of mining truck stop); a scenario, where one of the mining truck stops and the other mining trucks have to drive around or are even hampered in production; and further scenarios with varying parameters. According to some embodiments, the operational scenario tool may in particular be adapted for suggesting a selected (such as a best) scenario from the created operational scenarios for the production progress of the trolley assisted mining truck 200. The selected or best scenario may be chosen according to different guidelines (e.g. set by an operator or by predefined guidelines), such as a guideline for the maximum production efficiency, the lowest production cost, the lowest cost for mining truck maintenance, the maximum of hauled material from the mine, the fastest production, and the like.

The operational scenario tool may for instance be provided with processing power, storage devices and communication devices for calculating and communicating the selected scenario (e.g. to an operator, to the control unit or the traffic management tool).

Going back to the embodiment exemplarily shown in FIG. 2, the transport status unit 601 is located at the mining truck 200. Especially, the transport status unit 601 may be a part of the detection unit 600, as shown in the embodiment of FIG. 2. Additionally, or alternatively, the transport status unit 601 may (at least partially) be located outside the mining truck 200 within the system 100. For instance, parts of the transport status unit 601 or the whole transport status unit 601 may be placed at the path of the transport cycle 500, or within the traffic management tool 400. In the embodiment exemplarily shown in FIG. 1, a transport status unit device 900 of the transport status unit 601 is placed at a defined position of the transport cycle 500. According to some embodiments described herein, which may be combined with other embodiments described herein, the transport status unit device 900 may include one or more sensors (for instance light sensors or the like) for detecting and determining data of mining truck(s) passing by. Typically, the trucks approaching a trolley line are detected and their total height is verified to be lower than a certain maximum height.

According to some embodiments, the transport status unit may be equipped with several devices for determining the respective progress data, such as counter for counting the number of transport cycles of the mining truck, locality determination device for determining the position of a mining truck, communication device for communicating the data to the control unit, sensor (s) recognizing, which mining truck passes by, processing power and the like. According to some embodiments, the transport status unit may also include detection devices for detecting infrastructure conditions, devices for gathering data on equipment out of operation or toads in operation from other management system such as maintenance systems. In some embodiments, the transport status unit may get data from a mining truck, such as data regarding position, auxiliary power consumptions, and/or suspension movements. For instance, high suspension movements could indicate poor road conditions and lead to higher auxiliary power.

The embodiment of FIG. 2 also shows a first communication unit 700 in the mining truck 200. According to some embodiments described herein, the first communication unit 700 may be adapted for communicating data determined or gathered by the battery charge status unit 602, the transport status unit 601 and/or the detection unit 600 to the traffic management tool 400, especially to the control unit 401. According to some embodiments described herein, which may be combined with other embodiments described herein, a second communication unit 402 may be provided, e.g. within the traffic management tool 400, or as a part of the control unit 401. The second communication unit 402 may typically be adapted for communicating data of the control unit 401 and/or the traffic management tool 400 to the mining truck (s) 200 according to some embodiments. According to some embodiments, the first communication unit and/or the second communication unit may be provided with an antenna device, a WLAN receiver, a WLAN transmitter, means for radio communication, means for telephony and the like.

In the example shown in FIG. 2, the detection unit 600 is located in the mining truck 200. Typically, the detection unit 600 includes in the embodiment of FIG. 2 the battery charge status unit 602 and the transport status unit 601. As shown in FIG. 2, the battery charge status unit 602 of the mining truck 200 is typically directly connected to the battery 203. FIG. 2 also shows the first communication unit 700 being adapted for communicating information of the detection unit 600, especially the battery charge status unit 602 and/or the transport status unit 602 to the traffic management or the traffic management tool 400 including in particular the control unit 401 and typically the second communication unit 402.

According to some embodiments, which may be combined with other embodiments described herein, the mining truck 200 and/or the detection unit 600 may include a sensor unit. Typically, the sensor unit may include one or more sensors. According to some embodiments, the sensor unit may be adapted for gathering background data of the operation of the mining truck. The background data may for instance be indicative of a status of the trolley assisted mining truck 200, a status of a part of the trolley assisted mining truck 200, and/or a status of the environmental conditions of the trolley assisted mining truck 200.

In some embodiments, the sensor unit may (at least partially) be located on board of the mining truck or located outside the mining truck, such as along the transport cycle or the like.

FIG. 4 shows a mining truck 200 having one or more sensors according to embodiments described herein. In the embodiment shown in FIG. 4, a plurality of sensors 603, 604, 605, and 606 is shown belonging to the sensor unit. Typically, the one or more sensors may be provided (and placed) to gather background data, such as data referring to the status of the trolley assisted mining truck 200, a status of a part of the trolley assisted mining truck 200, such as wheels of the truck, the motor of the truck, the pantograph voltage, and the like, and/or a status of the environmental conditions of the trolley assisted mining truck 200. The mining truck 200 exemplarily shown in FIG. 4 may for instance include a sensor 606 for sensing and gathering data about a wheel suspension movement of the trolley assisted mining truck 200. The sensor 606 may respectively be placed at the mining truck, as can be seen in FIG. 4 at the wheel of the mining truck.

According to some embodiments, the mining truck 200 as shown in FIG. 4 may include a sensor 604 for sensing and gathering data about the payload 201 loaded on the mining truck.

FIG. 4 exemplarily shows a sensor 603 for sensing and gathering data about the environmental conditions, including for instance the humidity of the air, the temperature of the air, and/or the presence of rain or snow, and the like. The one or more sensors of the mining truck may typically include a sensor 605 for sensing and gathering data about further environmental conditions, such as the humidity of the ground, the temperature of the ground, the roughness of the ground, and/or the kind of ground the trolley assisted mining truck 200 is moving on.

The one or more sensors of a sensor unit according to embodiments described herein may include sensors for sensing further conditions, such as the running resistance of the trolley assisted mining truck 200 on the ground, the (auxiliary) energy consumption of the mining truck and the like.

The sensors as described herein may be understood as any kind of sensor being capable of sensing the respective conditions or data, and may for instance include optical sensing devices, acoustic sensing devices, piezoelectric or piezoresistive devices, and the like.

The sensor described in some embodiments herein may be located at different locations of the mining truck, especially at respective locations for sensing the respective data. According to some embodiments, the sensor(s) of the sensor unit as described herein may send their data to the first communication unit 700 of the mining truck and/or directly to the control unit 401.

In some embodiments, the control unit may be configured for calculating the need for maintenance of a mining truck. According to some embodiments, the sensor unit may be used for getting data about the proper function of (at least parts) of the mining truck. Such data (being for instance communicated to the control unit, the traffic management tool or an operator) may be used for recognizing the need for maintenance of a mining truck. In some embodiments, if the control unit determines based on the data received from the battery charge status unit that the battery charge is regularly or continuously lower than usual, or that the energy consumption of the mining truck is higher without any obvious (or sensed) causes (such as higher running resistance, damaged road surface or the like), the control unit may give a hint to the traffic management tool or an operator that the mining truck or the roads used may have the need for maintenance. According to some embodiments, which may be combined with other embodiments described herein, the system may be adapted for performing predictive maintenance, e.g. by using the data determined and gathered by the battery charge status unit and the transport status unit and by using a storage device of the control unit. In some embodiments, the operational scenario tool (as described above) may be used for predictive maintenance.

According to some embodiments, which may be combined with other embodiments described herein, the control unit 401 of the system 100 may include a self-learning tool. Typically, the self-learning tool may learn by data (continuously) provided to the self-learning tool, e.g. by the battery charge status unit, the transport status unit, the sensor unit, the control unit, the communication unit(s), and the like. In some embodiments, the self-learning unit may use continuing feedback from the detection unit 600, the transport status unit 601, and/or the battery charge status unit 602 for determining a schedule condition and/or for adapting the at least one operational parameter using the feedback. The feedback may include information regarding the real energy consumption of the mining truck. In some embodiments, the self-learning tool may learn from the provided data to estimate situations, upcoming events, working strategies, not-working strategies, estimate maintenance needs, correlations between different parameters, predict events and scenarios and the like.

Typically, correlations between different parameters learned by the self-learning tool may include the correlation between battery charge and operational parameters, such as battery charge and payload, battery charge and weather conditions, battery charge and ground conditions, battery charge and running hours of the mining truck, battery charge and adapted transport cycle, battery charge and previous adaption of operational parameters performed by the control unit, battery charge and previous adaption of the operation schedule performed by the control unit battery charge and age of the battery, and so on. In some embodiments, the self-learning tool may collect data regarding the effectiveness of adapted operational parameters or adapted operational schedule of the mining truck. Typically, the self-learning tool may be part of the control unit.

Typically, the self-learning tool may communicate with one or more other units provided in the system according to embodiments described herein. According to some embodiments, the self-learning tool may be connected with the operational scenario tool for supporting the operational scenario tool and/or for delivering information and data to the operational scenario tool. In some embodiments, the self-learning tool provides the generated data (e.g. about correlations of operational parameters) to the traffic management tool and/or to the control unit. The self-learning tool, the traffic management tool and/or the control unit may in particular use the generated data to improve the performance, e.g. to improve the adaption of operational parameters or the adaption of the operation schedule of a mining truck in case of a non-satisfactory schedule condition.

According to embodiments described herein, a method for controlling the electrical charging and/or the state of a battery of a trolley assisted mining truck 200 via one or more trolley line(s) 301, 302 is described. According to some embodiments, the trolley assisted mining truck and/or the trolley line(s) may be a mining truck and trolley line(s) as described in detail above. For instance, the trolley assisted mining truck 200 includes an electric drive, electric motors and a battery 203 for delivering energy to the electric drive and electric motors and carries out an operation schedule as described above.

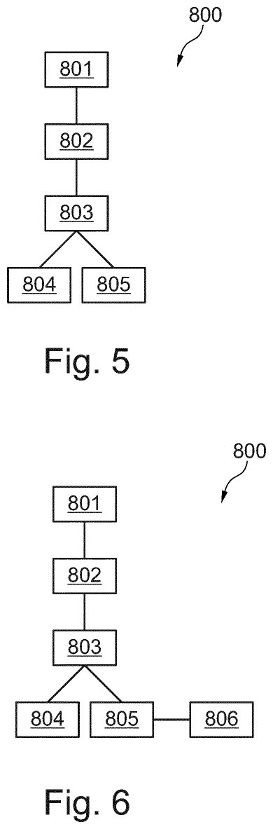

FIG. 5 shows a schematic flow chart of a method 800 according to embodiments described herein. The method 800 includes in block 801 determining by a battery charge status unit 602 battery charge status data indicative of the present charge status of the battery 203 of the trolley assisted mining truck 200. Further, the method 800 includes in block 802 determining by a transport status unit 601 progress data of the progress of the trolley assisted mining truck 200 in a present transport cycle 500 of the operation schedule.

According to embodiments described herein, the method includes in block 803 determining by the control unit 402 a schedule condition indicative of whether the operation schedule can be met based on the charge status determined by the battery charge status unit 602 and the progress data determined by the transport status unit 601. Typically, a schedule condition according to some embodiments described herein may be understood as a kind of test or check whether the operation schedule can be met or maintained by the mining truck. Typically, the control unit may calculate, based on the determined data of the battery charge status unit and the transport status unit, what kind of operation of the mining truck is possible, e.g. how many transport cycles are still possible with the battery charge status. In case the schedule condition is determined to be not satisfactory (that may mean that the operation schedule cannot be met with the data received from the battery charge status unit and the transport status unit, or that a sustainable state of battery cannot be obtained with the present data and operational parameter of the mining truck), the method 800 further includes in block 805 adapting at least one operational parameter and/or the operation schedule of the trolley assisted mining truck 200 for obtaining a sustainable state of battery charge.

According to some embodiments, a sustainable state of battery charge may for instance be understood as a state of the battery in the transport cycle allowing an infinite number of additional transport cycles (at least arithmetically). For instance, the adaption of operational parameter of the mining truck may lead to a sufficiently charged battery (in particular after each transport cycle) for arbitrarily extending the number of transport cycles of the mining truck. Adapting at least one operational parameter of the mining truck may generate the possibility to a continuous operation of the mining truck. It may be understood that the term “infinite number” of transport cycles may be used for an optimal system without wear, maintenance, and the like. Typically, the “infinite number” of transport cycles may e.g. be interrupted by maintenance needs or the like. In some embodiments, the term “sustainable state of battery charge” may be understood as relating to charging the battery in the mining truck so that the battery is not depleted or the mining truck has to stop operation. According to some embodiments, the term “sustainable state of battery charge” may be understood as relating to using the resource energy in the mining truck so that the battery is not depleted or the mining truck has to stop operation.

In block 805 of method 800, the schedule condition is determined to be satisfactory and the mining truck may continue its operation as done before.

In FIG. 6, the method 800 may further include block 806 specifying the adaption of operational parameter of block 805 according to some embodiments described herein. Typically, adapting an operational parameter as described in the method 800 herein may include adapting an operational parameter and/or the operation schedule, as described, explained and listed in detail above with respect to the system 100. The same may be valid for the progress data as used for the method.

It may be understood that the method may include further steps, e.g. for functions as described with respect to the system 100, especially with respect to the units of the system 100 as described above. For instance, the method may include factoring and considering the life span of the battery of the mining truck, when calculating measures for a sustainable truck operation. According to some embodiments, the life span of the battery may be considered when adapting operational parameter of the mining truck for obtaining a sustainable operation. According to some embodiments, the method may include sensing parameter(s) of the mining truck, parts of the mining truck, and/or environmental data, as described with respect to a sensor unit including one or more sensors (exemplarily shown in FIG. 4). Also, with respect to a sensing step of the method, the above description regarding the sensor unit of the system is valid for the method.

According to some embodiments, which may be combined with other embodiments, the method may include arranging the battery charge status unit 602 on the trolley assisted mining truck 200 and arranging the control unit 401 remotely from the trolley assisted mining truck. Typically, the method 800 may further include communicating the detected data of the battery charge status unit 602 and/or the transport status unit 601 to the control unit 401. Additionally, or alternatively, the method may include communicating data determined and calculated by the control unit 401 to the at least one trolley assisted mining truck 200, to the traffic management tool and/or an operator.

With a system according to embodiments described herein having a battery charge status unit, a transport status unit and a control unit adapting an operational parameter and/or the operation schedule of a mining truck according to the determined data of the battery charge status unit and the transport unit, it is possible to change or adjust the operation of the mining truck so that a sustainable operation of the mining truck becomes possible, and the operation schedule may in particular be met. By making an adjustment of the operational parameter of the mining truck and/or the operation schedule (e.g. the transport cycle), a situation where production is not sustainable can be changed into a situation where production is sustainable over time.

With embodiments described herein, it may also be possible to omit additional Diesel engines in the mining trucks, which can be provided for supporting the battery of a mining truck as a complementary generator. Also, no stationary charging (and, consequently, an interruption of the operation) is necessary for operation with embodiments described herein.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for controlling the electrical charging and/or state of battery of a trolley assisted mining truck connectable to one or more trolley lines, the trolley assisted mining truck having an electric drive and a battery for delivering energy to the electric drive, the trolley assisted mining truck carrying out an operation schedule including predefined transport cycles, the system comprising:
a detection unit comprising a battery charge status unit for determining battery charge status data indicative of the present charge status of the battery of the trolley assisted mining truck;
a transport status unit for determining progress data of the progress of the trolley assisted mining truck in a present transport cycle of the operation schedule;
a control unit for determining a schedule condition indicative of whether the operation schedule can be met and maintained based on the battery charge status data determined by the battery charge status unit and the progress data determined by the transport status unit the control unit being further configured to adapt, in case of the schedule condition being determined to be not satisfactory, at least one operational parameter and/or the operation schedule of the trolley assisted mining truck for obtaining a sustainable state of battery charge.

2. The system according to claim 1, wherein the progress data comprise data indicative of at least one of the position of the at least one trolley assisted mining truck the distance of the at least one trolley assisted mining truck to the trolley line the overall length of the transport cycle the remaining length of the transport cycle in the actual transport cycle, the duration of one transport cycle, the number of transport cycles gone by the trolley assisted mining truck, the number of transport cycles planned to go by the trolley assisted mining truck in the operation schedule, the time of operation of the trolley assisted mining truck, the remaining time of operation planned for the trolley assisted mining truck in the operation schedule, and the load on the at least one trolley assisted mining truck in the actual and/or previous transport cycle(s).

3. The system according to claim 1, wherein the operational parameter of the trolley assisted mining truck adapted by the control unit is at least one of the speed of the trolley assisted mining truck when in contact with the trolley line, the electrical current charged via the trolley line in a loading cycle of the trolley assisted mining truck, and the transport cycle of the mining truck, and/or
wherein the at least one operational parameter of the trolley assisted mining truck is adapted by the control unit for changing, especially increasing, the electrical charging of the trolley assisted mining truck via the trolley line and/or
wherein the at least one operational parameter and/or the operation schedule of the trolley assisted mining truck is adapted by the control unit for reducing the energy consumption from the battery during a transport cycle.

4. The system according to claim 1, wherein the operation schedule further comprises at least one of a time slot for a predetermined number of transport cycles, parameters of the transport cycle, the length of the trolley line, the path of the transport cycle, a number of transport cycles, the position of the trolley line, target operational parameter of the trolley assisted mining truck, in particular a target speed of the trolley assisted mining truck, and target charging parameters for the electrical charging of the trolley assisted mining truck via the trolley line.

5. The system according to claim 1, wherein the detection unit further comprises a sensor unit for gathering background data indicative of at least one of a status of the trolley assisted mining truck, a status of a part of the trolley assisted mining truck, and a status of the environmental conditions of the trolley assisted mining truck.

6. The system according to claim 5, wherein the background data comprises data indicative of at least one of the running resistance of the trolley assisted mining truck, a wheel suspension movement of the trolley assisted mining truck, the auxiliary energy consumption, the load loaded on the trolley assisted mining truck, and environmental conditions,
wherein the environmental conditions include: the humidity of the air, the humidity of the ground, the temperature of the air, the temperature of the ground, the presence of rain or snow, the roughness of the ground, and the kind of ground the trolley assisted mining truck is moving on.

7. The system according to claim 1, wherein the detection unit is arranged on the trolley assisted mining truck and the control unit is arranged remotely from the trolley assisted mining truck, the system further comprising: a first communication unit for communicating the data determined by the detection unit and, in particular the transport status unit, to the control unit; and/or
a second communication unit for communicating data of the control unit to the trolley assisted mining truck.

8. The system according to claim 1, wherein the control unit comprises a self-learning tool using continuing feedback from the detection unit and the transport status unit, for determining a schedule condition and/or for adapting the at least one operational parameter using the feedback.

9. The system according to claim 1, wherein the control unit is adapted to factor the life span of the battery when calculating the battery charging power, if the control unit adapts the at least one operational parameter of the trolley assisted mining truck for obtaining a sustainable state of battery charge for the operation schedule.

10. The system according to claim 9, wherein the control unit is adapted to calculate an optimum of battery charging of the mining truck and life span of the battery.

11. A method for controlling the electrical charging and/or the state of a battery of a trolley assisted mining truck connectable to one or more trolley line(s), the trolley assisted mining truck having an electric drive and a battery for delivering energy to the electric drive, the trolley assisted mining truck carrying out an operation schedule including predefined transport cycles, the method comprising:
determining by a battery charge status unit battery charge status data indicative of the present charge status of the battery of the trolley assisted mining truck;
determining by a transport status unit progress data of the progress of the trolley assisted mining truck in a present transport cycle of the operation schedule; and
determining by a control unit a schedule condition indicative of whether the operation schedule can be met based on the charge status determined by the battery charge status unit and the progress data determined by the transport status unit and in case of the schedule condition being determined to be not satisfactory, adapting at least one operational parameter and/or the operation schedule of the trolley assisted mining truck for obtaining a sustainable state of battery charge.

12. The method according to claim 11, wherein adapting the operational parameter of the trolley assisted mining truck by the control unit includes adapting at least one of the speed of the trolley assisted mining truck when in contact with the trolley line, the electrical current charged via the trolley line in a loading cycle of the trolley assisted mining truck, and the transport cycle of the mining truck; and/or
wherein adapting the at least one operational parameter of the trolley assisted mining truck by the control unit includes changing, especially increasing, the electrical charging of the trolley assisted mining truck via the trolley line; and/or
wherein adapting the at least one operational parameter and/or the operation schedule of the trolley assisted mining truck by the control unit includes reducing the energy consumption from the battery during a transport cycle.

13. The method according to a claim 11, wherein determining the progress data by the transport status unit includes determining at least one of the location of the at least one trolley assisted mining truck, the distance of the at least one trolley assisted mining truck to the trolley, the overall length of the transport cycle the remaining length of the transport cycle in the actual cycle, the duration of one transport cycle the number of transport cycles gone by the trolley assisted mining truck, the number of transport cycles planned to go by the trolley assisted mining truck, the time of operation of the trolley assisted mining truck, the remaining time of operation planned for the trolley assisted mining truck, and the load on the trolley assisted mining truck in the transport cycle.

14. The method according to claim 11, further comprising factoring by the control unit the life span of the battery when calculating the battery charging power, if the at least one operational parameter of the trolley assisted mining truck is adapted by the control unit for obtaining a sustainable state of battery charge for the operation schedule.

15. The method according to claim 11, further comprising detecting by a sensor unit background data indicative of at least one of a status of the trolley assisted mining truck a status of a part of the trolley assisted mining truck, and a status of the environmental conditions of the trolley assisted mining truck,
wherein the background data comprise in particular at least one of data indicative of the running resistance of the trolley assisted mining truck, data indicative of a wheel suspension movement of the trolley assisted mining truck, the auxiliary energy consumption, the load loaded on the trolley assisted mining truck, and environmental conditions,
wherein the environmental conditions include: the humidity of the air, the humidity of the ground, the temperature of the air, the temperature of the ground, the presence of rain or snow, the roughness of the ground, and the kind of ground the trolley assisted mining truck is moving on.

16. The system according to claim 2, wherein the operational parameter of the trolley assisted mining truck adapted by the control unit is at least one of the speed of the trolley assisted mining truck when in contact with the trolley line, the electrical current charged via the trolley line in a loading cycle of the trolley assisted mining truck, and the transport cycle of the mining truck, and/or
wherein the at least one operational parameter of the trolley assisted mining truck is adapted by the control unit for changing, especially increasing, the electrical charging of the trolley assisted mining truck via the trolley line, and/or
wherein the at least one operational parameter and/or the operation schedule of the trolley assisted mining truck is adapted by the control unit for reducing the energy consumption from the battery during a transport cycle.

17. The system according to claim 2, wherein the operation schedule further comprises at least one of a time slot for a predetermined number of transport cycles, parameters of the transport cycle, the length of the trolley line, the path of the transport cycle, a number of transport cycles, the position of the trolley line, target operational parameter of the trolley assisted mining truck, in particular a target speed of the trolley assisted mining truck, and target charging parameters for the electrical charging of the trolley assisted mining truck via the trolley line.

18. The system according to claim 2, wherein the detection unit further comprises a sensor unit for gathering background data indicative of at least one of a status of the trolley assisted mining truck, a status of a part of the trolley assisted mining truck, and a status of the environmental conditions of the trolley assisted mining truck.

19. The system according to claim 2, wherein the detection unit is arranged on the trolley assisted mining truck and the control unit is arranged remotely from the trolley assisted mining truck, the system further comprising: a first communication unit for communicating the data determined by the detection unit and, in particular the transport status unit, to the control unit; and/or
a second communication unit for communicating data of the control unit to the trolley assisted mining truck.

20. The system according to claim 2, wherein the control unit comprises a self-learning tool using continuing feedback from the detection unit and the transport status unit, for determining a schedule condition and/or for adapting the at least one operational parameter using the feedback.
